(19) United States
(12) Patent Application Publication
(10) Pub. No.: US 2026/0008163 A1
(43) Pub. Date: Jan. 8, 2026

(54) DEVICE AND METHOD FOR CHANGING WHEEL LUG NUT COVERS

(71) Applicant: 16128483 CANADA INC., Waterloo (CA)

(72) Inventor: James Gordon, Waterloo (CA)

(21) Appl. No.: 19/257,140

(22) Filed: Jul. 1, 2025

Related U.S. Application Data
(60) Provisional application No. 63/666,979, filed on Jul. 2, 2024.

(51) Int. Cl. B25B 27/00; B25B 21/00; B60B 7/06

(52) U.S. Cl. CPC B25B 27/0035; B25B 21/002; B60B 7/068

(57) ABSTRACT

A device and method for changing lug nut covers is provided. The device includes a cylinder with a wrench end and an opposing power tool end. The cylinder has a length extending from the wrench end that has a smaller diameter than a length extending from the power tool end. The wrench end is hexagonal shaped for fitting to a lug nut cover wrench and the power tool end encloses an aperture for fitting to a power tool bit. The method includes attaching the device to a lug nut cover wrench through a hexagonal-shaped cylinder in a wrench end of the device, placing the lug nut cover wrench over a lug nut cover, inserting a power tool bit into an aperture enclosed in an opposing power tool end of the device, and torquing the device using the power tool to remove or attach the lug nut cover.

This application claims priority as a non-provisional to U.S. Provisional Application 63/666,979, filed on Jul. 2, 2024, and presently pending. The contents of that application are hereby incorporated by reference.

### TECHNICAL FIELD OF THE INVENTION

The present invention relates to vehicle maintenance and, specifically, to truck wheel maintenance.

### BACKGROUND

Truck wheels typically have lug nuts that must be changed periodically. To change the lug nuts, a threaded lug nut cover must be removed from each lug nut and reinstalled. Typically, the lug nut covers are removed using pliers, but that method is tedious and slow, and the process may scratch the lug nut covers. More recently, a device to assist in removing and attaching threaded lug nut covers became available, referred to as a lug nut cover wrench. The lug nut cover wrench is a hexagonal-shaped hollow cylinder that fits over the lug nut cover and provides the ability to torque threaded nut covers, for example, using a screwdriver through holes in the sides of the lug nut cover wrench. Although the lug nut cover wrench assists with the removal and re-attachment of lug nut covers, the process remains a tedious task since hundreds of lug nut covers may need to be removed for a single vehicle. What is lacking in the field is a device and method for the rapid and simple removal of lug nut covers.

### SUMMARY

The present disclosure provides a solution to enable rapid and easy removal and attachment of lug nut covers.

Thus, in one broad aspect of the present disclosure, a device to assist in removing and attaching lug nut covers is provided. The “jimmy block” device includes a cylinder with a wrench end and an opposing power tool end. The cylinder has a proximal length extending from the wrench end that has a smaller diameter than a distal length extending from the power tool end. The wrench end is a hexagonal-shaped cylinder that reversibly fits a lug nut cover wrench, and the power tool end encloses an aperture for reversibly fitting to a power tool bit.

In another aspect of the present disclosure, a method for removing lug nut covers is provided. The method includes attaching a jimmy block device to a lug nut cover wrench through a hexagonal shaped cylinder in a wrench end of the jimmy block, placing the lug nut cover wrench over a lug nut cover, inserting a power tool bit into an aperture enclosed in an opposing power tool end of the jimmy block, and torquing the jimmy block using the power tool to remove or attach the lug nut cover.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1 is a side view of an embodiment of a lug nut cover of the present disclosure.

FIG. 2 is a side view of an example of a lug nut cover wrench of the present disclosure.

FIG. 3 is a side view of an embodiment of a jimmy block of the present disclosure and a power tool with a bit for torquing the jimmy block.

### DETAILED DESCRIPTION

The device is a block, herein referred to as a “jimmy block”, for fitting to a lug nut cover wrench and enabling the removal and attachment of lug nut covers using a power tool or any ½ inch ratchet. The structure is preferably made of a hard plastic, for example, using a 3D printer, ensuring a lightweight and durable product that is inexpensive and simple to manufacture.

The jimmy block is cylindrical in shape and has two opposing ends of the cylinder. The first end is for attaching the jimmy block to a lug nut cover wrench, and the second opposing end is for attaching the jimmy block to a power tool. The length of the cylinder at the wrench end has a smaller diameter (for example, ½ inch) than the length of the cylinder at the power tool end. The wrench end is a hexagonal shape to fit into the lug nut cover wrench (also referred to as a torque tube), for example, a 33 mm hexagonal shape. At the end of the power tool end, there is an aperture with a square (for example, ½ inch) or other shaped aperture to fit to a power tool bit. In a preferred embodiment, the jimmy block cylinder is a hexagonal cylinder for ease of manufacture to fit the lug nut cover torque wrench. Also, in a preferred embodiment, the jimmy block is manufactured from a hard plastic and can be made using a 3-dimensional printer.

In a further embodiment of the device, the wrench end may come in different sizes and be interchangeable on the jimmy block, allowing it to be used with corresponding different lug nut cover wrenches (torque tubes) and sizes.

The jimmy block may be provided commercially as a kit that includes a jimmy block, a power tool bit, and a lug nut cover wrench, each of which is sized to fit together.

To use the jimmy block for removing and attaching lug nut covers, the hexagonal-shaped wrench end of the jimmy block device is attached to a lug nut cover wrench through the hexagonal opening in the wrench. The lug nut cover wrench is placed over a lug nut cover. A power tool is connected to the jimmy block by fitting the power tool bit into the aperture in the power tool end of the jimmy block. The power tool is then used to torque the jimmy block, thereby removing or attaching the lug nut cover to the vehicle wheel.

In a non-limiting example of the present invention, the lug nut cover is a 33 mm threaded lug nut cover, and the lug nut cover wrench is a TRUX 33 mm threaded lug nut cover wrench. In a further example, the power tool end is a ½ inch power tool end.

For different applications or sizes of lug nut covers, alternate lug nut cover wrenches may be needed. Therefore in a further embodiment, the wrench end of the jimmy block may be selected from an interchangeable selection of different sizes of wrench ends.

As described herein, the jimmy block may be used for changing wheel lug nut covers, however, the jimmy block may also be used in other applications, for example, in torquing lug nuts of wheels and other structures.

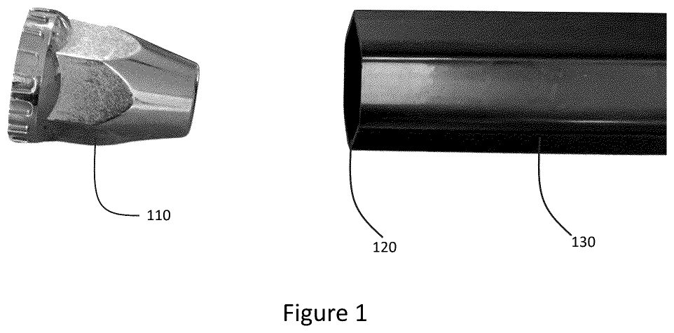

Referring to FIG. 1, an example of a lug nut cover 110 is shown, together with an end 120 of a lug nut cover wrench 130 with a hexagonal opening that fits over the lug nut cover.

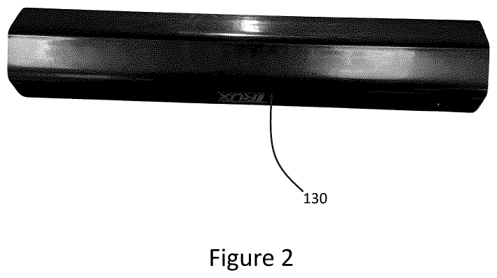

Referring to FIG. 2, the lug nut cover wrench 130, partially shown in FIG. 1 is illustrated.

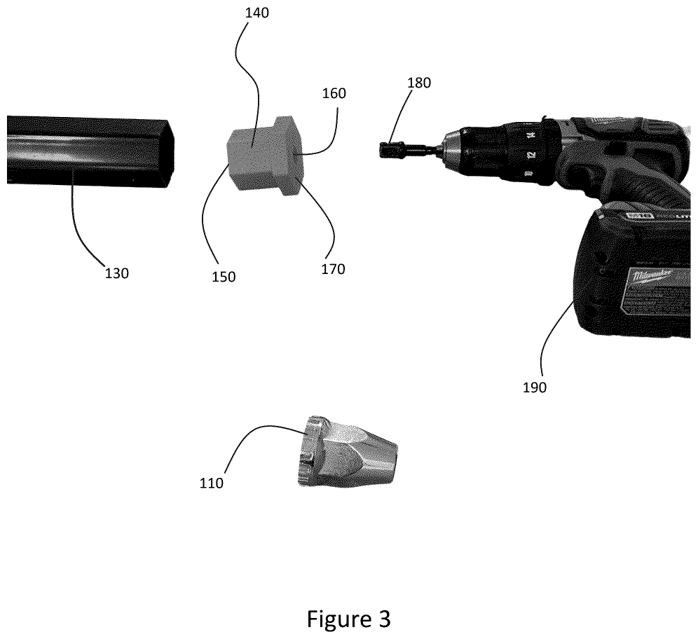

Referring to FIG. 3, an example of a jimmy block 140 of the present disclosure is shown, with the wrench end 150 of a hexagonal shape to fit into the cover wrench 130 and an aperture 160 in the power tool end 170 to accommodate the power tool bit 180. The power tool 190 is used to torque the jimmy block 140 and thereby remove or attach the lug nut cover 110.

What is claimed is:

1. A jimmy block device for changing lug nut covers, the device comprising:
a cylinder, having a wrench end and an opposing power tool end;
wherein the cylinder has a proximal length extending from the wrench end with a smaller diameter than a distal length extending from the power tool end;
and further wherein the wrench end comprises a hexagonal-shaped cylinder for reversibly fitting to a lug nut cover wrench, and the power tool end encloses an aperture for reversibly fitting to a power tool bit.

2. The device of claim 1, wherein the cylinder comprises a hexagonal cylinder.

3. The device of claim 1, wherein the device is manufactured from a plastic.

4. The device of claim 1, wherein the wrench end comprises a plurality of interchangeable wrench ends, each having a different shape or size for reversibly fitting to a respective one of a plurality of lug nut cover wrenches.

5. The device of claim 1, wherein the lug nut covers are truck wheel lug nut covers.

6. A method for removing and attaching lug nut covers, the method comprising:
attaching a jimmy block device to a lug nut cover wrench through a hexagonal cylinder in the jimmy block;
wherein the jimmy block device comprises
a cylinder having a power tool end and an opposing wrench end;
a proximal length extending from the wrench end with a smaller diameter than a distal length extending from the power tool end; and
the wrench end comprises a hexagonal shaped cylinder for reversibly fitting to the lug nut cover wrench and the power tool end encloses an aperture for reversibly fitting to a power tool bit;
placing the lug nut cover wrench over a lug nut cover;
inserting a bit connected to a power tool into the aperture enclosed in the power tool end of the jimmy block;
torquing the jimmy block using the power tool to remove or attach the lug nut cover.

7. The method of claim 6, further wherein attaching the jimmy block device to the lug nut cover comprises:
selecting one of a plurality of wrench ends to fit the lug nut cover; and
attaching the selected wrench end to the lug nut cover wrench.

8. The method of claim 6, wherein placing the lug nut cover wrench over the lug nut cover comprises placing the lug nut cover wrench over a truck wheel lug nut cover.

9. The device of claim 1, wherein the power tool end comprises a square-shaped aperture sized to receive a ½ inch power tool bit.

10. The device of claim 1, wherein the wrench end is configured to mate with a 33 mm hexagonal lug nut cover wrench.

11. The device of claim 1, wherein the jimmy block is produced via additive manufacturing using a 3D printer.

12. The device of claim 1, wherein hard plastic used in construction comprises acrylonitrile butadiene styrene (ABS) or polylactic acid (PLA).

13. The device of claim 1, wherein the wrench end and the power tool end are configured to be reversibly attachable to corresponding components using snap-fit or friction-fit mechanisms.

14. The device of claim 1, further comprising a storage kit including the jimmy block, at least one lug nut cover wrench, and at least one compatible power tool bit.

15. The device of claim 7, wherein interchangeable wrench ends comprise at least one of: a 32 mm, 33 mm, or 34 mm hexagonal adapter.

16. The device of claim 1, wherein the jimmy block is color-coded for size differentiation of interchangeable components.

17. The device of claim 1, wherein the cylinder comprises surface texturing or knurling to improve manual grip.

18. The method of claim 6, wherein the power tool is selected from a cordless electric drill, pneumatic wrench, or an impact driver.

19. The method of claim 6, wherein the jimmy block is utilized on at least one of: a commercial truck wheel, a bus wheel, or a trailer wheel.

20. The method of claim 6, further comprising calibrating torque output from the power tool to ensure non-damaging engagement with the lug nut covers.
